(19) United States
(12) Patent Application Publication
(10) Pub. No.: US 2007/0059004 A1
(43) Pub. Date: Mar. 15, 2007

(54) HEATING ROLLER AND IMAGE FORMING APPARATUS HAVING THE SAME

(76) Inventor: Dong-kyun KANG, Suwon-si (KR)

Correspondence Address: STANZIONE & KIM, LLP, 919 18TH STREET, N.W., SUITE 440, WASHINGTON, DC, 20006, US

(21) Appl. No.: 11/530,990

(22) Filed: Sep. 12, 2006

(30) Foreign Application Priority Data
Sep. 15, 2005 (KR) 2005-86487

(51) Int. Cl. G03G 15/00; G03G 15/20

(52) U.S. Cl. 399/45; 399/69

(57) ABSTRACT

A heating roller and an image forming apparatus including the heating roller. The image forming apparatus can include: an image forming part to apply a developer selectively on a paper to form an image; a paper sensing part to sense the size of the paper fed to the image forming part; a heating roller including a cylindrical roller main body, a first heating part provided in a first area of the roller main body to generate heat, and a second heating part provided in a second area of the roller main body to generate heat; and a controller to control the first heating part and/or the second heating part to selectively heat the paper according to the sensing result of the paper sensing part. Thus, a heating roller capable of controlling a heating range in accordance with a width of object media is possible.

### CROSS-REFERENCE TO RELATED APPLICATIONS

This application claims priority from Korean Patent Application No. 2005-0086487, filed on Sep. 15, 2005, in the Korean Intellectual Property Office, the disclosure of which is incorporated herein in its entirety by reference.

### BACKGROUND OF THE INVENTION

1. Field of the Invention

The present general inventive concept relates to a heating roller and an image forming apparatus including the heating roller, and more particularly, to a heating roller having a plurality of coils to heat different areas thereof and an image forming apparatus including the heating roller.

2. Description of the Related Art

A heating roller as a part used for an image forming apparatus, etc., is used to heat and/or press object media with a pressure roller. Here, the pressure roller is provided along with the heating roller.

FIG. 1 is a sectional view illustrating a conventional heating roller 10.

The heating roller 10 comprises a cylindrical roller main body 11 and a coil 12 provided inside of the roller main body 11. Electric power is supplied to the coil 12 to operate the heating roller 10, and heat generated from the coil 12 is transmitted to the outside through the roller main body 11.

However, the conventional heating roller 10 has a problem in that the coil 12 is wound with a uniform interval over the whole length in the internal side of the heating roller 10, and as a result, the whole roller main body 11 is heated uniformly regardless of the size of a transferring media to be heated and/or pressed.

In this case, when the size of the heated and pressed transferring medium, for example, the width of a printing paper, is smaller than the heating width of the heating roller 10 during a heating operation, an area where the printing paper does not contact the heating roller 10 occurs, and accordingly energy is consumed unnecessarily. Moreover, the temperature difference between a paper passing area and a paper non-passing area increases. In particular, when the paper non-passing area is overheated, a safety device provided in the heating roller 10 is activated, and thus the heating roller 10 stops operating or breaks down.

Also, in the case that the surface temperature of the heating roller 10 increases above a normal value when heating or pressing toner particles formed on the paper, a “hot offset” of an image occurs.

The above-mentioned problems with the conventional heating roller 10 occurs frequently in the case that the axial length of the heating roller 10 is long, for example, in the case of a large heating roller used to form an image on a large paper, such as A3 size paper.

### SUMMARY OF THE INVENTION

The present general inventive concept provides a heating roller which is capable of controlling a heating range in accordance with a width of object media.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept can be achieved by providing an image forming apparatus, comprising: an image forming part to apply selectively a developer on a paper to form an image; a paper sensing part to sense a size of the paper fed to the image forming part; a heating roller comprising a cylindrical roller main body, a first heating part provided in a first area of the roller main body to generate heat, and a second heating part provided in a second area of the roller main body to generate heat; and a controller to control the first heating part and/or the second heating part to selectively heat the paper according to the sensing result of the paper sensing part.

The first heating part can be provided in a central area of the roller main body, and the second heating part can be provided at both sides of the central area.

The heating roller can comprise a left area and a right area which are disposed in a lengthwise direction thereof, and the first heating part and the second heating part can be provided in the left area and right area, respectively.

Each of the first and second heating parts can comprise a plurality of heating areas, and the controller can control the respective heating areas to be separately heated.

The first heating part and second heating part can comprise the first coil and the second coil, respectively, each of which is provided in the inside of the roller main body, and separately heated according to control of the controller.

The image forming apparatus may further comprise an insulator interposed between the first coil and the second coil.

The first coil and the second coil, respectively, can be wound up with different diameters on a central axis in a lengthwise direction of the roller main body.

The first coil can differ in winding turns from the second coil.

The image forming apparatus can further comprise a supporting pipe provided inside of the roller main body to support the first and second coils.

The image forming apparatus can further comprise an insulator interposed among the roller main body, the first coil, the second coil, and the supporting pipe.

The foregoing and/or other aspects and utilities of the present general inventive concept can also be achieved by providing a heating roller, comprising: a roller main body; a first heating part provided in a first area of the roller main body to generate heat; a second heating part provided in a second area of the roller main body to generate heat; and a controller to control the first heating part and/or the second heating part to selectively heat the paper depending on a size of the paper.

The foregoing and/or other aspects and utilities of the present general inventive concept can also be achieved by providing a heating roller, comprising: a roller main body having a cylindrical shape; a center coil provided inside of the roller main body to heat a central area of the roller main body; a side coil provided inside of the roller main body to heat side areas of the roller main body; and a plurality of connecting terminals disposed on opposite end parts of the roller main body and having electrodes electrically connected to the center coil and the side coil.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a sectional view illustrating a conventional heating roller,

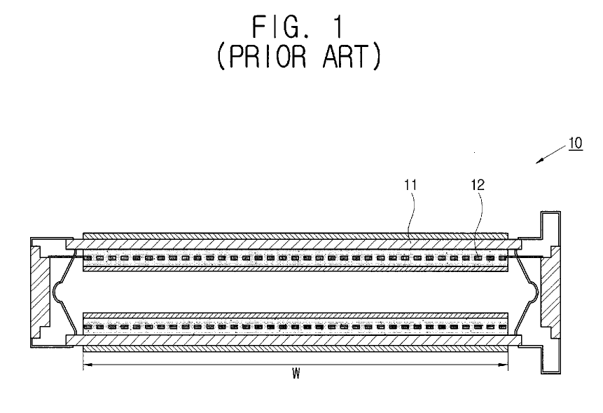

FIG. 2 is a block diagram illustrating a configuration of an image forming apparatus according to an embodiment of the present general inventive concept,

FIG. 3 is a sectional view illustrating a heating roller according to the embodiment of FIG. 2,

FIG. 4 is a schematic view illustrating the configuration of the image forming apparatus to according to the embodiment of FIG. 2, and

FIG. 5 is an exemplary diagram illustrating a configuration of a heating roller according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

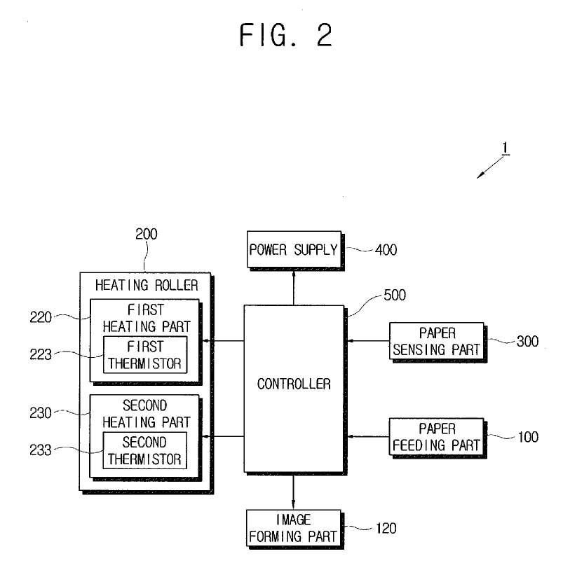

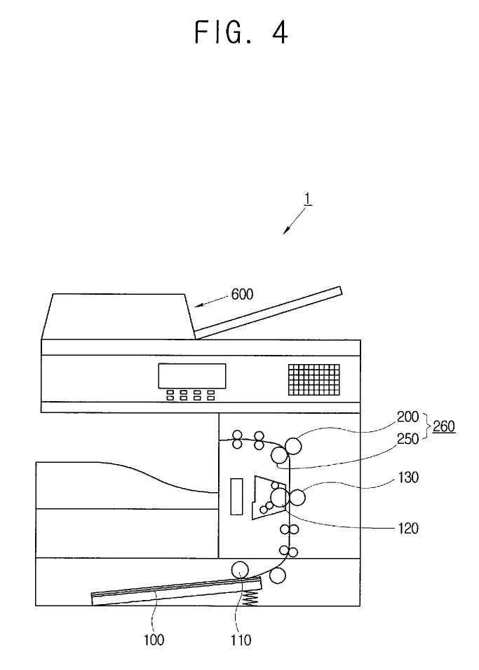

FIG. 2 is a block diagram illustrating a configuration of an image forming apparatus 1 according to an embodiment of the present general inventive concept. As illustrated therein, the image forming apparatus 1 according to the embodiment of FIG. 2 comprises a paper feeding part 100 feeding a paper to feed paper, a paper sensing part 300 to sense a size of the paper being fed from the paper feeding part 100, an image forming part 120 to form an image on the paper, an image fixing part 260 (see FIG. 4) to fix the image to the paper, and a power supply 400 to supply power to the image fixing part 260.

As illustrated in FIG. 4, the paper feeding part 100 may accommodate a plurality of papers on an inside surface thereof. When an image output signal is applied to the image forming apparatus 1, the paper feeding part 100 feeds a paper to the image forming part 120 by using a pick-up roller 110.

The paper sensing part 300, which is provided between the paper feeding part 100 and the image forming part 120, senses a size of the fed paper and delivers the sensed result to a controller 500. The paper sensing part 300 may contact the paper to sense the size of the paper, but is not limited thereto. For example, the paper sensing part 300 may alternatively sense the size of the paper through mutual signals of a light emission part and a light receiving part. The paper sensing part 300 may also be constructed with one of various known ways to sense the size of the paper.

The image forming part 120 applies selectively a developer on the paper to form an image by using an electrical potential difference. This image forming part 120 has a similar configuration as a conventional image forming part. Accordingly, a detailed description thereof is omitted to keep the detailed description herein brief.

The image fixing part 260 heats and presses the paper in which the image forming part 120 has applied the developer thereon, so as to fix the developer to the paper. Herein, the image fixing part 260 comprises a pressure roller 250 to press the paper and a heating roller 200 to heat the paper.

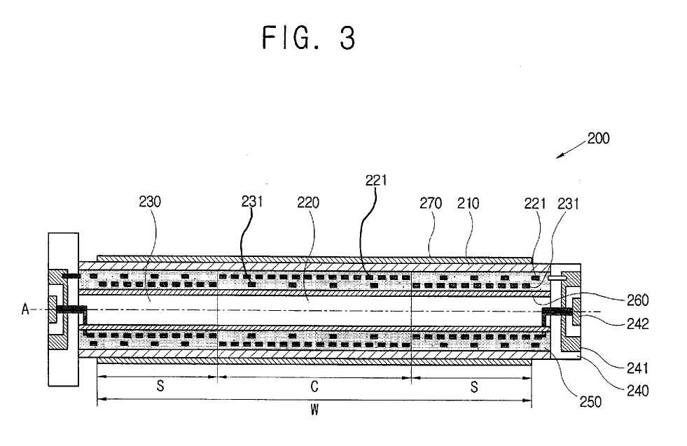

As illustrated in FIG. 3, the heating roller 200 according to the present embodiment comprises a first heating part 220 provided in a central area C of a roller main body 210, and a second heating part 230 provided at both side areas S of the first heating part 220. Further, the first heating part 220 includes a center coil 221 provided therein and a side coil 231 provided therein. Each second heating part 230 includes the side coil 231 provided therein and the center coil 221 provided therein. Here, each of the center and side coils 221 and 231 heat both the first and second heating parts 220 and 230. However, the center and side coils 221 and 231 heat both the first and second heating parts 220 and 230 to a different degree, which will be described in more detail infra. Also, each of the center and side coils 221 and 231 is connected to a connecting terminal 240. Here, the power supply 400 supplies power to the respective center and side coils 221 and 231 through f the connecting terminal 240.

The center coil 221 and the side coil 231 are fixably located on different diameters, respectively, based on a central axis A of the roller main body 210. Between the center coil 221 and the side coil 231 is interposed an insulator 250 to fixably support the coils 221 and 231 and to prevent the coils 221 and 231 from contacting each other.

In the inside of the center coil 221 and the side coil 231 is a supporting pipe 260 made of a material comprising aluminum. The center coil 221 and the side coil 231 are radially supported by the supporting pipe 260. The insulator 250 is interposed between the center coil 221 and the roller main body 210 and between the side coil 231 and the supporting pipe 260 to support the coils 221 and 231 and to prevent electric contact among the respective elements.

As described above, the center and side coils 221 and 231 are in both the first and second heating parts 220 (C) and 230 (S) of the roller main body 210 and heat both the first and second heating parts 220 and 230. However, in the roller main body 210, the center coil 221 in the central part C has more winding turns than in the side parts S. Accordingly, when heating the center coil 221, the heating roller 200 has a higher temperature in the central part C than in the side parts S.

In contrast with the central coil 221, the side coil 231 has more winding turns in the side parts S of the roller main body 210 than in the central part A thereof. As a result, when heating the side coil 231, the temperature of the side parts S of the heating roller 200 becomes higher than that of the central part C.

On each side of the roller main body 210, the connecting terminal 240 is positioned and connected with the center coil 221 and the side coil 231. The connecting terminal 240 comprises a first electrode 241 of a ring shape and a second electrode 242 formed in the central part thereof. The first electrode 241 is electrically connected with the center coil 221 and the second electrode 242 is electrically connected with the side coil 231. External power supplied from the power supply 400 is provided through the first electrode 241 and the second electrode 242 to the coils 221 and 231, respectively.

Further, the first and second heating parts 220 and 230 comprise a first thermistor 223 and a second thermistor 233, respectively, so as to measure the temperature of the area of each heating part. The first and second thermistors 223 and 233 measure the temperature of each area and can deliver the measured results to the controller 500.

A coating layer 270 made of the material comprising PTFE (Poly Tetra Fluoro Ethylene), which is known as the trademark ‘Teflon’ is formed on an external surface of the roller main body 210.

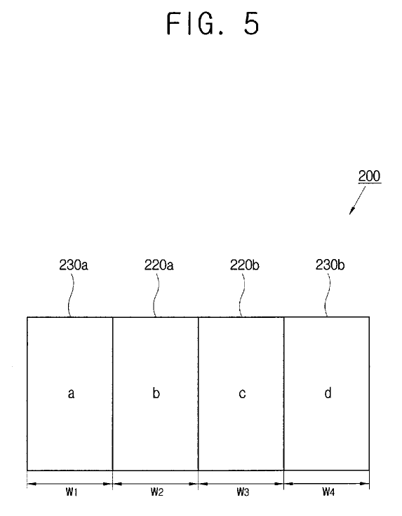

The roller main body 210 is divided into the first heating part 220 in the center area C and the second heating parts 230 in two side areas S, but is not limitable thereto. Alternatively, the roller main body 210 may be divided into the first heating part 220 in one left area and the second heating part 230 in one right area, and vice versa. The first and second heating parts 220 and 230, respectively, may also be divided into a plurality of areas. In another embodiment, as illustrated in FIG. 5, the first and second heating parts 220 and 230 are divided into two areas 220a and 220b, and 230a and 230b, respectively. At this time, each of the divided areas 220a and 220b, and 230a and 230b includes a heating coil to generate heat by power supplied from the power supply 400, and a thermistor to measure the temperature of the respective areas. In another embodiment, the configuration of dividing the roller main body 210 and the number of the divided areas therein may be varied depending on the size and the type of the fed papers. Also, the configuration of dividing the roller main body 210 and the number of the divided areas therein may be varied according to paper feeding types such as a center feeding and a side feeding.

The power supply 400 supplies power selectively to the center coil 221 and the side coil 231 provided inside of the heating roller 200 through the first and second electrodes 241 and 242.

The controller 500 controls the power supply 400 to heat the first and/or second heating parts 220 and 230 selectively according to the sensed result of the paper sensing part 300. Also, the controller 500 controls the power supplied from the power supply 400 to the center and side coils 221 and 231, respectively, depending on the temperature results measured by the first and second thermistors 223 and 233.

Hereinafter, an operation of the heating roller 200 of the image forming apparatus 1 having the above described configuration will be described with reference to FIG. 2 through 4.

First, the pick-up roller 110 of the paper feeding part 100 feeds a paper according to an image output signal. At this time, the paper sensing part 300 senses the size of the fed paper and delivers the sensed result to the controller 500. The image forming part 120 applies the developer selectively on the fed paper by applying a transition voltage between the image forming part 120 and a transfer roller 130 so as to form an image on the paper using the developer.

The fed paper, which the image forming part 120 applies the developer thereon, is delivered to the image fixing part 260. At this time, the controller 500 recognizes the sensed result transferred from the paper sensing part 300, and then controls the power supply 400 to selectively heat the first and second heating part 220 and 230.

For example, when the paper sensing part 300 senses that the size (width) of the fed paper corresponds with the width W of the heating roller 200 (referring to FIG. 3), the controller 500 controls the power supply 400 to heat evenly the first and second heating parts 220 and 230 so that the two part 220 (area C) and 230 (areas S) can be heated with the same temperature. That is, the controller 500 controls the power supply 400 to provide even power to both the center coil 221 and the side coil 231.

When the paper sensing part 300 senses that the size (width) of the provided paper corresponds with the width C of the first heating part 220, the controller 500 controls the power supply 400 to provide power to only the center coil 221.

On the other hand, in the case in which another paper having a width corresponding to the width W of the heating roller 200 is fed after a paper having a width corresponding to the width C of the first heating part 220 is fed, the temperature of the first heating part 220 measured by the first thermistor 223 will be different (higher) from that of the second heating part 230 measured by the second thermistor 233. At this time, the controller 500 controls the power supply 400 to make the second heating part 230 be more quickly heated than the first heating part 220 so that the temperature of the second heating part 230 will be the same as the temperature of the first heating part 220. That is, the controller 500 controls the power supply 400 to supply more power to the side coil 231 than the center coil 221 until the first and second heating parts 220 and 230 have the same temperature.

According to the foregoing operations, the heating roller 200 heats the paper and the pressure roller 250 presses the paper to fuse the developer to the paper, thereby completing formation of an image. Then, papers are discharged to an outside of the image forming apparatus 1 through a discharging part thereof (not illustrated).

As described above, according to the embodiments of the present general inventive concept, there is provided a heating roller capable of controlling a temperature thereof by individual areas depending on a size of fed papers and a feeding type thereof.

As apparent from the above description, according to the embodiments of the present general inventive concept, a heating roller using a center coil and a side coil provided in an inside of a roller main body can control the temperature of a central part and side parts of the heating roller separately. Hence, by selectively operating a center coil and a side coil according to the width of a media being heated by the heating roller, overheating of the heating roller as well as breakdown of the roller can be provided.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
an image forming part to selectively apply a developer on a paper to form an image;
a paper sensing part to sense a size of the paper fed to the image forming part;
a heating roller comprising a cylindrical roller main body, a first heating part provided in a first area of the roller main body to generate heat, and a second heating part provided in a second area of the roller main body to generate heat; and
a controller to control the first heating part and/or the second heating part to selectively heat the paper according to the sensing result of the paper sensing part.

2. The image forming apparatus according to claim 1, wherein the first heating part is provided in a central area of the roller main body, and the second heating part is provided at opposite sides of the central area.

3. The image forming apparatus according to claim 1, wherein the heating roller comprises a left area and a right area which are disposed in a lengthwise direction thereof, and the first heating part and the second heating part are provided in the left area and right area, respectively.

4. The image forming apparatus according to claim 3, wherein each of the first and second heating parts comprises a plurality of heating areas, and the controller controls the respective heating areas to be separately heated.

5. The image forming apparatus according to claim 2, wherein each of the first and second heating parts comprises a plurality of heating areas, and the controller controls the respective heating areas to be separately heated.

6. The image forming apparatus according to claim 1, wherein each of the first and second heating parts comprises a plurality of heating areas, and the controller controls the respective heating areas to be separately heated.

7. The image forming apparatus according to claim 1, wherein the first heating part and second heating part comprises the first coil and the second coil, respectively, each of which is provided in the inside of the roller main body, and separately heated according to control of the controller.

8. The image forming apparatus according to claim 7, further comprising an insulator interposed between the first coil and the second coil.

9. The image forming apparatus according to claim 7, wherein the first coil and the second coil are wound up with different diameters along a central axis in a lengthwise direction of the roller main body.

10. The image forming apparatus according to claim 9, wherein the first coil differs in winding turns from the second coil.

11. The image forming apparatus according to claim 8, wherein the first coil differs in winding turns from the second coil.

12. The image forming apparatus according to claim 7, wherein the first coil differs in winding turns from the second coil.

13. The image forming apparatus according to claim 9, further comprising a supporting pipe provided inside of the roller main body to support the first and second coils.

14. The image forming apparatus according to claim 13, further comprising an insulator interposed among the roller main body, the first coil, the second coil, and the supporting pipe.

15. The image forming apparatus according to claim 8, further comprising a supporting pipe provided inside of the roller main body to support the first and second coils.

16. The image forming apparatus according to claim 15, further comprising an insulator interposed among the roller main body, the first coil, the second coil, and the supporting pipe.

17. The image forming apparatus according to claim 7, further comprising a supporting pipe provided inside of the roller main body to support the first and second coils.

18. The image forming apparatus according to claim 17, further comprising an insulator interposed among the roller main body, the first coil, the second coil, and the supporting pipe.

19. A heating roller, comprising:
a roller main body;
a first heating part provided in a first area of the roller main body to generate heat;
a second heating part provided in a second area of the roller main body to generate heat; and
a controller controlling the first heating part and/or the second heating part to selectively heat the paper depending on the size of the paper.

20. A heating roller, comprising:
a roller main body having a cylindrical shape;
a center coil provided inside of the roller main body to heat a central area of the roller main body;
a side coil provided inside of the roller main body to heat side areas of the roller main body; and
a plurality of connecting terminals disposed on opposite end parts of the roller main body and having electrodes electrically connected to the center coil and the side coil.
